(19) United States
(12) Patent Application Publication
(10) Pub. No.: US 2019/0092498 A1
(43) Pub. Date: Mar. 28, 2019

(54) APPARATUS AND METHOD FOR SATELLITE PAYLOAD DEVELOPMENT

(71) Applicant: Open Cosmos Ltd., London (GB)

(72) Inventors: Rafael Jordá SIQUIER, London (GB); Han LAI, London (GB); Aleix Megias HOMAR, London (GB); Jordi Barrera ARS, London (GB); Mark COWAN, London (GB)

(73) Assignee: Open Cosmos Ltd., London (GB)

(21) Appl. No.: 16/082,285

(22) PCT Filed: Mar. 7, 2017
(86) PCT No.: PCT/GB2017/050610

§ 371 Date: Sep. 5, 2018

(30) Foreign Application Priority Data
Mar. 7, 2016 (GB) 1603920.8

(51) Int. Cl. B64G 7/00; G06F 17/50; B64G 1/64; B64G 1/42; B64G 1/66

(52) U.S. Cl. CPC B64G 7/00; G06F 17/5009; B64G 1/66; B64G 1/428; B64G 1/641

(57) ABSTRACT

An apparatus for development and/or testing of a payload for a satellite, comprising: a payload interface operable to connect to the payload; and a communication link, operable to couple the apparatus with a computer; wherein the apparatus is operable to emulate one or more subsystems of the satellite, such that the behaviour of the payload when connected to the apparatus via the payload interface and communication link is the same as when in the satellite.

The present invention relates to satellite payload development. More particularly, the present invention allows the simulation of satellite mission and payload control.

Man-made satellites enable a large range of functionality, including for example global communication, navigation, and observation.

Satellites may receive data and control signals transmitted from the Earth, and these signals can then be transmitted to other satellites, via other satellites, and/or back down to the Earth. Satellites therefore allow signals to be transmitted between and/or over geographical areas of the Earth that may not otherwise be easily accessible. Data can be transmitted over significant distances using satellites and without the complex infrastructure required to transmit the same information over the same distances using equivalent ground communication systems.

Satellites conventionally orbit the Earth at heights above ground level ranging from 160 km to 36,000 km, depending on the selected orbit. At these heights they remain free from obstructions such as tall buildings and can provide coverage over large geographical areas.

Approximately 6,600 artificial satellites have been launched up to the present day, and that number is set to increase significantly. Satellites are conventionally categorised by size, with ‘small satellites’ referring to satellites with of a mass of 500 kg or less. NASA refers to small satellites as ‘SmallSats’, which it defines as satellites with a mass less than 180 kilograms and about the size of a large kitchen fridge. Nanosatellites' are a particular category of small satellite, defined by NASA as satellites with a wet mass of between 1 kg to 10 kg.

CubeSats are a particular class of nanosatellites that are configured to carry a payload. A standard CubeSat is in the form of a cube (or “block”) having a unit volume of 10×10×10 cms, referred to as “one unit” (“1U”), and a mass of less than 1.33 kgs. The size of a CubeSat may be extended to 1.5U, 2U, 3U, 6U or 12U, for example.

As a result of their size, CubeSats cannot carry large payloads. However, typical payloads include cameras, telescopes and various types of sensors, for example. The viability of such relatively small satellites has, in particular, been made possible in recent years through the miniaturization of electronic componentry.

At present, limited propulsion systems are available for such nanosatellites. However, multiple CubeSats may still be arranged to form orbiting constellations, in which the CubeSats may communicate between each other, for example.

Smaller satellites, such as nanosatellites, are clearly a very cost-effective means by which to both explore space and monitor Earth as they can reduce the cost and/or increase the efficiency of launching satellites. For example, heavier satellites require larger rockets with greater thrust to propel them into their eventual orbit. Smaller satellites, such as CubeSats, can ‘piggyback’ on those larger rockets, which are already scheduled to launch a primary contract satellite (or satellites) but where there is still rocket payload capacity.

The addition of a smaller satellite to such a rocket payload is unlikely to unduly affect the fuel requirements for the rocket, as rocket fueling requirements are significantly dictated by the maximum payload capacity. Larger rockets may therefore also provide a launch method for multiple smaller satellites, and so obviate the need for multiple launches and/or provide a lower launch cost-per-satellite.

Thus, small satellites, such as CubeSats, may be launched either as a primary payload of a rocket, or as secondary payloads. It may also be possible for such small satellites to be launched from the International Space Station (ISS), if first delivered to the ISS as part of another payload. As a result, an increasing number of companies and private individuals are keen to develop and launch satellites into space and competition and innovation in the rocketry services business is therefore increasing too.

However, while the cost of launching a small satellite may be becoming more viable, development of the small satellite itself remains very expensive. Each small satellite must be individually developed, tested and custom built, with strategies planned to mitigate risks to the effectiveness of its payload in orbit during the intended mission, which is typically performed using unproven custom-built electronics, bought-in subsystems where the developer has to learn how to operate them and make them work as a system, and/or expensive electronics with space flight heritage. As a result, satellite development and ownership largely remains the preserve of well-capitalised companies, governments, large conglomerates, universities and very wealthy individuals.

Described herein is an apparatus for development and/or testing of a payload for a satellite, comprising: a payload interface operable to connect to the payload; and a communication link, operable to couple the apparatus with a computer; wherein the apparatus is operable to emulate one or more subsystems of the satellite, such that the behaviour of the payload when connected to the apparatus via the payload interface and communication link is the same as when in the satellite.

The apparatus allows payload development and testing from scratch and/or configuration of an existing payload for integration with a satellite. The apparatus may emulate the subsystems of a satellite (e.g. electrical power system, on-board data handling, attitude determination and control, transceiver, etc.), such that the behaviour of the payload when connected with the apparatus is the same as when connected in the (actual) satellite.

In at least one embodiment, the apparatus can allow for a number of elements (for example, the payload interfaces) to remain unchanged when developing/testing a payload for a satellite. Conventional satellite development requires a significant number of elements to be developed, including the payload, contributing to the relatively high cost of development. By keeping a number of elements the same in the satellite, once those elements are developed and tested the testing process does not need to be duplicated (e.g. to the same extent, if at all) for the next launch.

Where such elements are kept the same the only development and most of the testing required is then in relation to the payload when connected to the payload bus (e.g. “payload interface”), the reactions of which during one or more (e.g. orbit) simulations can be monitored and then analysed using the apparatus, optionally supported by a simulator such as a spacecraft simulator, which may be run on a computer coupled to the apparatus.

The vast majority of satellites are equipped with a payload, which may vary according to the intended function of the satellite. Payloads vary significantly in size, weight and requirements, and therefore must be taken into consideration when a satellite is developed.

Optionally, the apparatus further comprises a data interface module operable to be connected to the payload via the payload interface, such that data can be communicated between the computer and the payload via the data interface module.

Optionally, the apparatus further comprises a power interface module arranged to be coupled to a power supply, whereby to supply power to the payload, for example via a payload power interface. Optionally, the power interface module provides a power source to the data interface module. Optionally, the power interface module is operable to receive power from the power supply, which power supply may include at least one of: mains supply (e.g. AC), generator, battery and a computer. Optionally, the power supplied to the payload comprises a potential difference of between 1 and 24 volts, for example one of: 3.3 volts; 5 volts; 12 volts; or 24 volts (other voltages may of course be used). Optionally, the data interface module is operable to supply both data and power to the payload.

Optionally, the apparatus may further comprise multiple payload interfaces arranged to communicate data and power with the payload, separately. Optionally, multiple interfaces (i.e. two or more) may be provided for communicating data with the payload.

Optionally, the communication link may be arranged to provide a wireless connection, such as a Bluetooth, with the computer, or a wired connection such as a USB cable, for example. The communication link may comprise a communication interface, which may be a physical interface or it may be a software implemented interface.

Optionally, the data interface module is mounted inside a container, which may comprise one or more of: a satellite circuit board; a plurality of satellite circuit boards optionally arranged in a stack, a mezzanine arrangement or a back plane system; or protective shielding, as would be required to protect the satellite during orbit.

Optionally, the apparatus further comprises a housing for the payload interface and/or communication link, and preferably also for the data interface module and/or the power interface module. The housing may be arranged to have substantially the same dimensions and/or volume as one or more subsystems of the satellite to be used with the payload.

The housing may comprise at least one mechanical interface for securing the apparatus to another structure, framework and/or panel.

Optionally, the apparatus is configured to develop and/or test a payload for satellite that has a wet mass of less than 500 kg. Preferably, the apparatus is configured to develop and/or test a payload for a satellite that has a wet mass of between 1 kg and 25 kg, and preferably a wet mass of between 1 kg and 10 kg, for example a nanosatellite such as a CubeSat. Small satellites, with a wet mass of less than 500 kg, or optionally with a wet mass of between 1 kg and 25 kg, can be carried into orbit in great numbers by a single rocket and at a lower cost per satellite. They therefore provide a number of advantages over larger and/or heavier satellites.

Optionally, the data interface module is coupled to one or more of: the payload; the computer; the power interface module; or the power supply module. In order to extract as much useful data as possible from the apparatus during payload development, in some embodiments the data interface module is coupled to one or more of a number of different modules. Data from each module to which the data interface module is coupled can therefore be recorded and analysed. Such data may provide insights as to the behaviour of the satellite when it is launched, or raise issues which need addressing before a launch is feasible.

Optionally, the apparatus may be operable to be controlled by the computer to simulate conditions that the payload may undergo in a satellite, allowing hardware-in-the-loop payload development and testing, for example wherein the computer is controlled to act as a spacecraft simulator.

Optionally, the computer is operable to act as a spacecraft simulator providing data on one or more of: position; attitude and orbit control subsystem parameters; power subsystem parameters; run mode; deployables status; electronics system configuration; OBC subsystem parameters, firmware management and file management; reset settings; thermal subsystem parameters and control; or redundancy settings.

Optionally, the data interface module and/or power interface module is/are operable to be controlled by the computer to simulate conditions that the payload may undergo in the satellite, for example when the satellite is in orbit, such that behaviour of the payload under such conditions can be monitored and/or the payload operated.

In some embodiments, a simulation (for example a spacecraft simulation) can be used to predict the performance of a payload in one or more missions, for example a sun synchronous orbit mission. A local power supply can provide such power to the payload required during a simulation in place of a satellite power source such as a battery and/or solar panels. A power interface module can allow for the regulation of the power supply to the apparatus depending on the simulated power supply, for example to take into account varying power being supplied from solar panels and/or the characteristics of power supplied from a battery over time.

A feedback mechanism may be employed so that the power supply can be varied according to the needs and responses of the payload and/or simulated satellite characteristics. A number of other modules, for example the modules which comprise the communication link and/or the payload interface, may also require power and so can be connected to the power source via the power interface module.

Optionally, the performance (or behaviour) of a payload may be tested under varying environmental conditions. Optionally, the environmental conditions may comprise one or more of: a reduction in air pressure, vibration of the apparatus; a reduction or increase in ambient temperature; or a change in radiation levels. In order to test the behaviour of a payload under varying environmental conditions, a pressurised (or other environment simulating) chamber, or other suitable test apparatus, may be employed, into which the payload may be placed, as appropriate.

It can be beneficial for a simulation of predicted behaviour of a satellite to model the actual future behaviour of the satellite and payload as closely as possible, so that any issues with the payload which arise may be resolved before the actual satellite is launched. Therefore in some embodiments the entire development and/or testing apparatus can be subjected to varying environmental conditions, which may serve to more accurately recreate the environmental conditions into which the satellite will eventually be launched.

Large amounts of data may be relevant to the successful launch and continued use of a satellite. In some embodiments, the simulation data provided by the development and/or testing apparatus may provide useful information in relation to the satellite and the payload once it is launched, for example data in relation to the payload communication to the rest of the satellite. If the simulation shows that the payload has some incompatibility with the rest of the satellite, the issue can be solved in a much less costly manner while the payload is still in development rather than attempting any repair or modification once the satellite is launched. Important satellite systems, such as the Attitude Determination and Control (ADCS), on-board computer (OBC) and electrical power system (EPS) can also be simulated to ensure full capabilities of the satellite function as expected.

Optionally, the computer is operable to simulate multiple satellites simultaneously and/or inter-satellite communication. Satellites can coordinate with each other in groups, constellations or ‘swarms’. It is therefore advantageous that in some embodiments multiple satellites can be simulated, so as to gather data in relation to a satellite's performance alongside other satellites.

Optionally, a (payload mounting) framework is provided, the framework defining a payload volume, for example to which to mount the payload. The payload may be positioned within the payload volume, optionally mounted (or otherwise secured and/or fixed) to the framework.

Also described herein is a system for development and/or testing of a payload for a satellite, comprising: a framework for supporting the payload in a desired orientation; and an apparatus operable to connect to the payload; wherein the apparatus is operable to emulate one or more subsystems of the satellite.

As described above, the apparatus may be operable to emulate one or more subsystems of the satellite such that the behaviour of the payload when mounted in the framework and connected to the apparatus is the same as (when integrated and/or installed) in the (actual) satellite and herein.

A controller may be arranged to control the apparatus and the payload connected thereto, for example wherein the controller is a computer. A power supply module arranged to supply power to the apparatus.

The framework (of the apparatus and/or system) may be modular, preferably wherein the size of the framework can be reconfigured, for example wherein the framework may comprise two or more separate frame modules connected together. The two or more adjacent frame modules may be secured together by connecting members. The framework may be configured to correspond to the structure and/or dimensions of the satellite, which satellite may be a CubeSat, for example. Optionally, the framework have a size (or configuration) of between 1U and 12U, where U is a unit volume having a dimension of 10×10×10 cms, according to the CubeSat standard. The framework may be arranged to define a payload volume that is substantially the same volume as the payload volume of the satellite.

The framework (of the apparatus and/or system) may include one or more partitions for compartmentalising the framework, for example wherein the partitions may be provided by one or more rib members. The framework may be configured such that at least a portion of the framework can be replaced with a payload or a dummy payload, for example, whereby to maintain structural integrity of the framework. One or more panels may be arranged at least in part to enclose at least a section or portion of the framework.

A dummy module may be arranged (or mounted) in the framework to simulate the volume and/or mass properties of one or more subsystems in the satellite, for example wherein the dummy module is arranged to fit within the framework, for example wherein the dummy module is arranged to be integrated as part of the structure of the framework.

Also described herein is a system for development and/or testing of a payload for a satellite, comprising: hardware capable to couple the payload with a computer, including at least one of a mechanical interface (structure) and an electrical interface (power and data buses); and software configured to perform satellite mission simulation and/or hardware-in-the-loop payload operations.

According to a further aspect, there is provided a machine-readable map, or machine-readable instructions, configured to enable a 3D printer (or any printer or manufacturing device/system) to manufacture the framework and/or connecting members.

The framework and/or connecting members may be commonly manufactured in metal or using a mould-injection process comprising one or more plastics, such as polyurethane, alongside a heat transfer sticker.

Also described herein is a method for testing a payload for a satellite, the method comprising the steps of: connecting the payload to an apparatus for testing and/or development of a payload for a satellite; and wherein the apparatus is operable to couple to a computer and one or more simulations can be performed in relation to the payload.

Also described herein is a method for development and/or testing of a payload for a satellite, the method comprising the steps of: providing an apparatus operable to emulate one or more subsystems of the satellite; connecting the payload to said apparatus; and performing one or more simulations on the payload to determine the likely behaviour of the payload in orbit. As described above, the apparatus may be operable to emulate one or more subsystems of the satellite such that the behaviour of the payload when connected to the apparatus is the same as (when integrated and/or installed) in the (actual) satellite.

Optionally, the payload may be mounted in a desired orientation within a framework that corresponds to the structure of the satellite. The one or more simulations may be performed on the payload in various different orientations, for example to determine the best orientation and/or configuration of the payload in the satellite.

Optionally, the one or more simulations are performed on a computer that is coupled to the payload via the data interface module and/or the apparatus.

Optionally, the behaviour of the payload may be determined (or tested) under varying environmental conditions, for example wherein the payload and apparatus are placed in an appropriate test chamber. The environmental conditions may comprise one or more of: a reduction in air pressure, vibration of the apparatus; a reduction or increase in ambient temperature; or change in the radiation levels.

Optionally, the method may comprise the use of the apparatus or system described herein.

Also described herein is a method for developing and/or testing a payload for a satellite, the method comprising: simulating one or more conditions of a space mission on a computer; controlling the payload to undergo one or more of said simulated conditions;

and monitoring the payload to determine its behaviour while undergoing the one or more simulated conditions.

Optionally, the computer may be operable to act as a spacecraft simulator providing data on one or more of: position; attitude and orbit control subsystem properties; power subsystem parameters; run mode; power control; deployables status; electronics system configuration; firmware management; reset settings; thermal subsystem parameters and control; or redundancy settings.

Optionally, the simulation may be created using actual space flight data, for example obtained from previous missions. Optionally, the computer may be further operable to simulate multiple satellites simultaneously and/or inter-satellite communication. Optionally, the payload may be connected to an apparatus as described above and herein according.

According to another aspect there is provided a computer program product operable to perform the method described above and herein. The computer program product may be further arranged and/or operable to control the payload in the satellite (as well as during testing and/or development), for example by using the same user interface for both the simulation and the actual control.

In the apparatus, system and/or method described herein, the payload may be for a satellite having a wet mass of less than 500 kg, preferably a satellite having a wet mass of between 1 kg and 25 kg, and more preferably for a nanosatellite having a wet mass of between 1 kg and 10 kg, for example a CubeSat.

Also described herein is satellite for use with a payload developed and/or tested using the apparatus, system and/or method described above and herein, preferably wherein the satellite is small satellite, and more preferably a nanosatellite, for example a CubeSat.

The invention extends to a kit of parts comprising one or more aspects of the system or apparatus described herein.

The invention also extends to an apparatus or system substantially as herein described and/or illustrated in the accompanying figures.

As used herein, the term “computer” includes mobile computing devices, such as smart phones, tablet devices, and similar devices, as well as laptop and desktop computers.

At least one embodiment of the present invention will now be described, by way of example and with reference to the accompanying drawings, having like-reference numerals, in which:

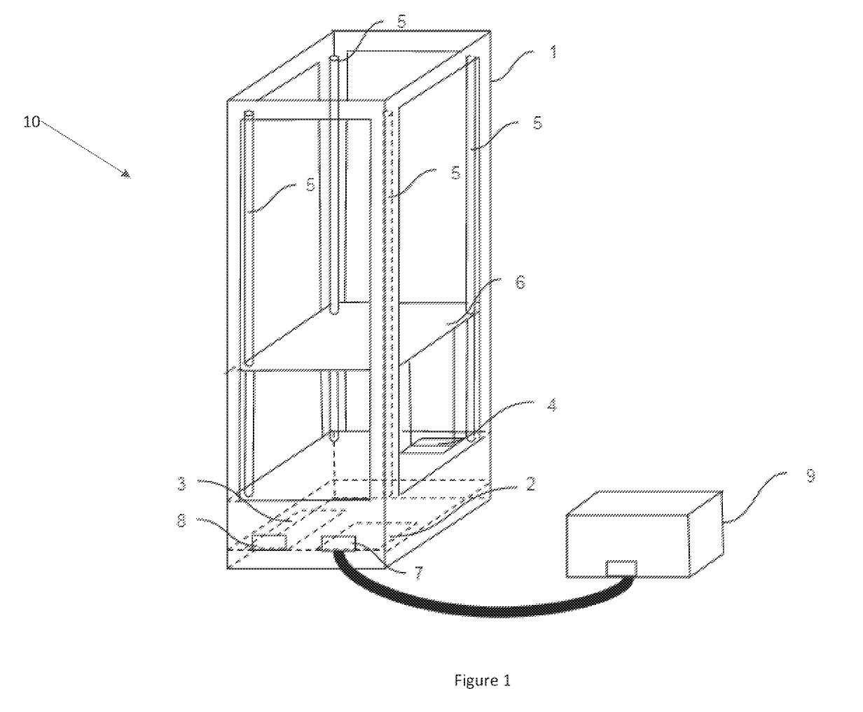

FIG. 1 shows an apparatus having a framework for mounting a payload for a satellite;

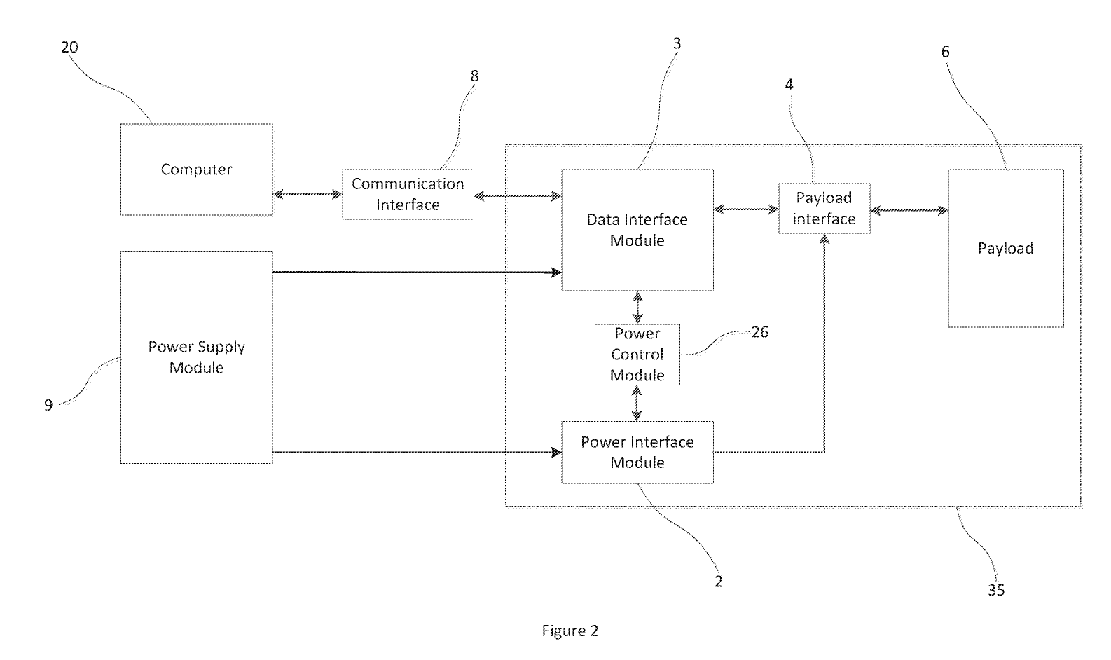

FIG. 2 is a block diagram of a system incorporating the apparatus of FIG. 1;

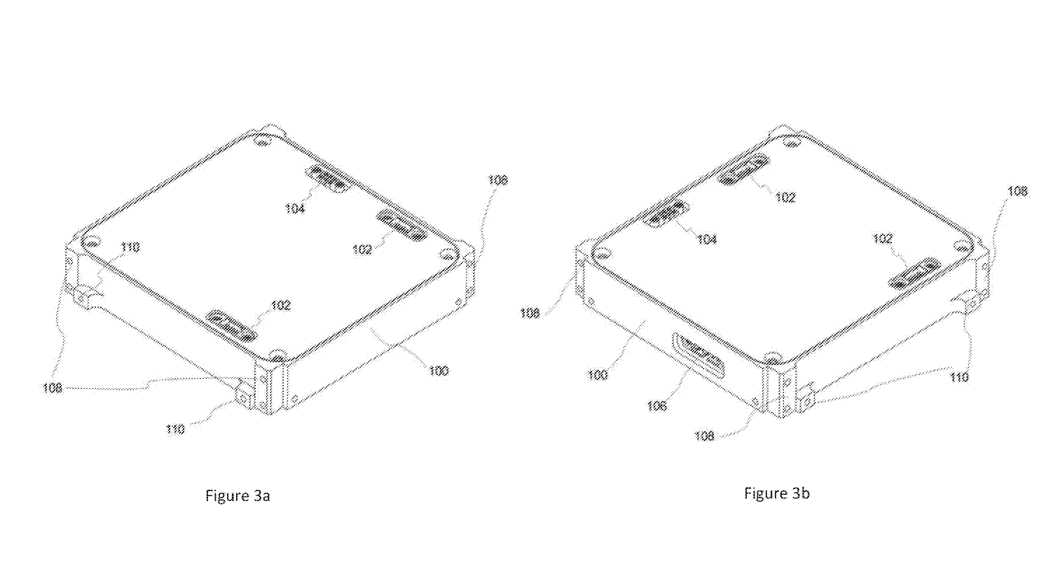

FIGS. 3a and 3b show a further apparatus without a framework in two different orientations;

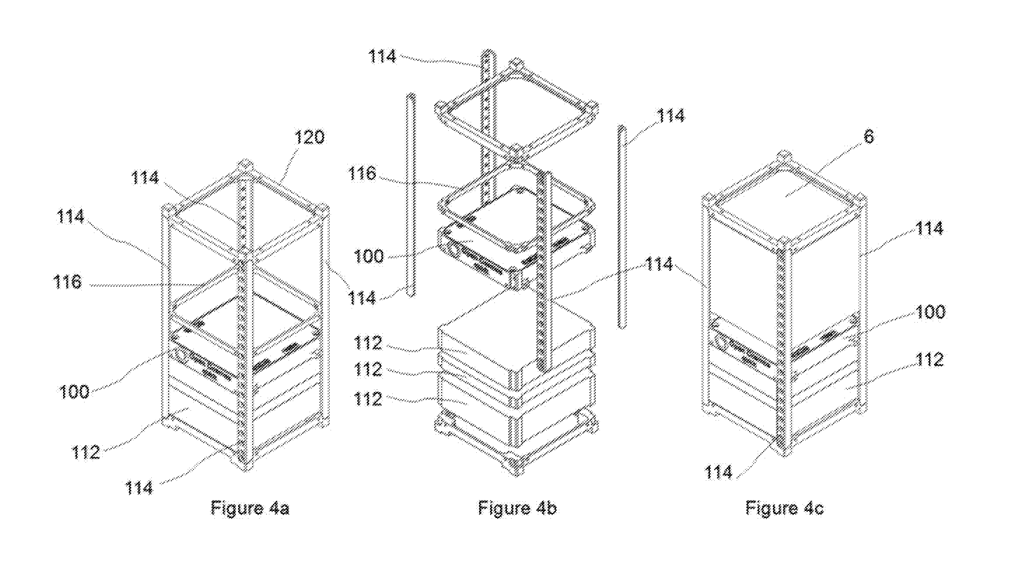

FIGS. 4a, 4b and 4c show the apparatus mounted within a modular framework, an exploded view of the framework, and a payload further provided in the framework, respectively;

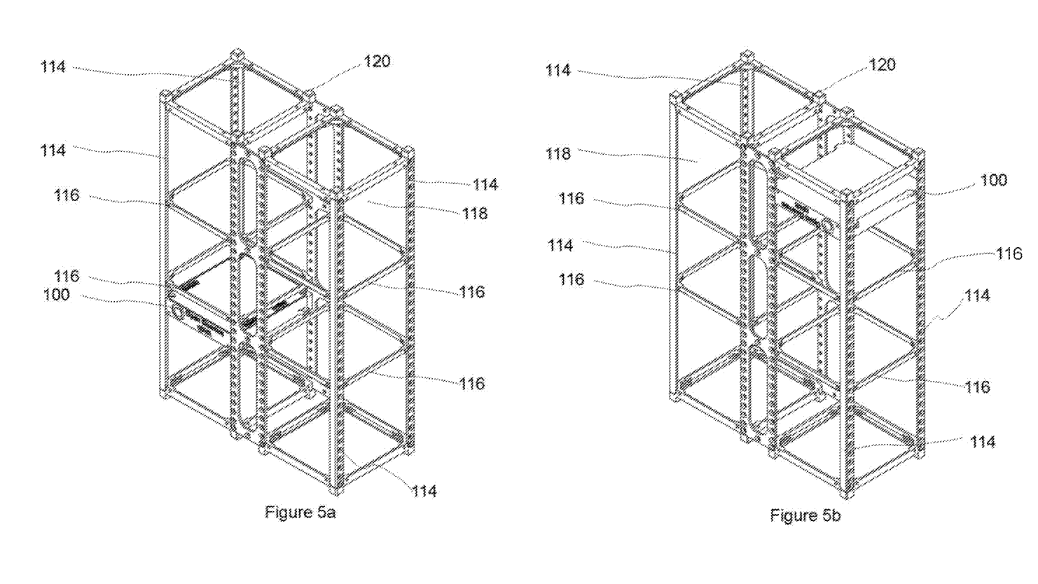

FIGS. 5a and 5b show the apparatus mounted in a modular framework in two different configurations, respectively;

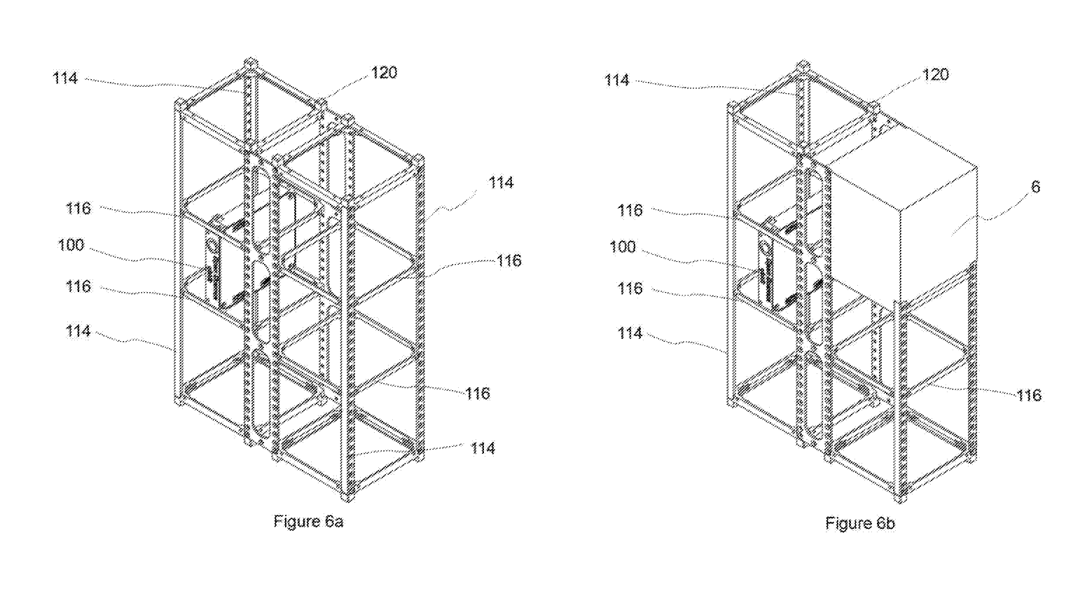

FIGS. 6a and 6b show a further configuration of the apparatus mounted in a modular framework, and that same configuration with the addition of a payload, respectively;

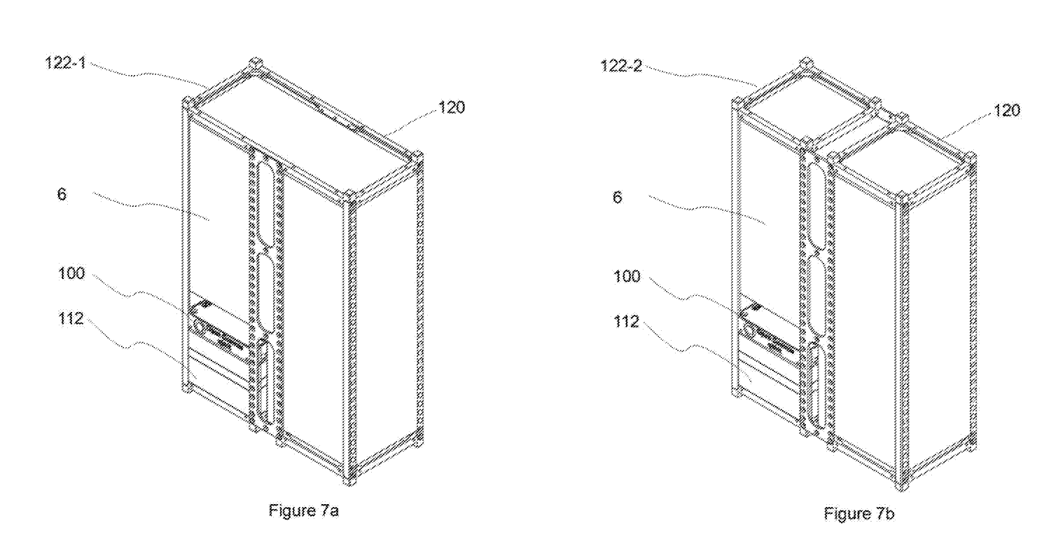

FIGS. 7a and 7b show two different framework configurations having the apparatus and payloads mounted therein;

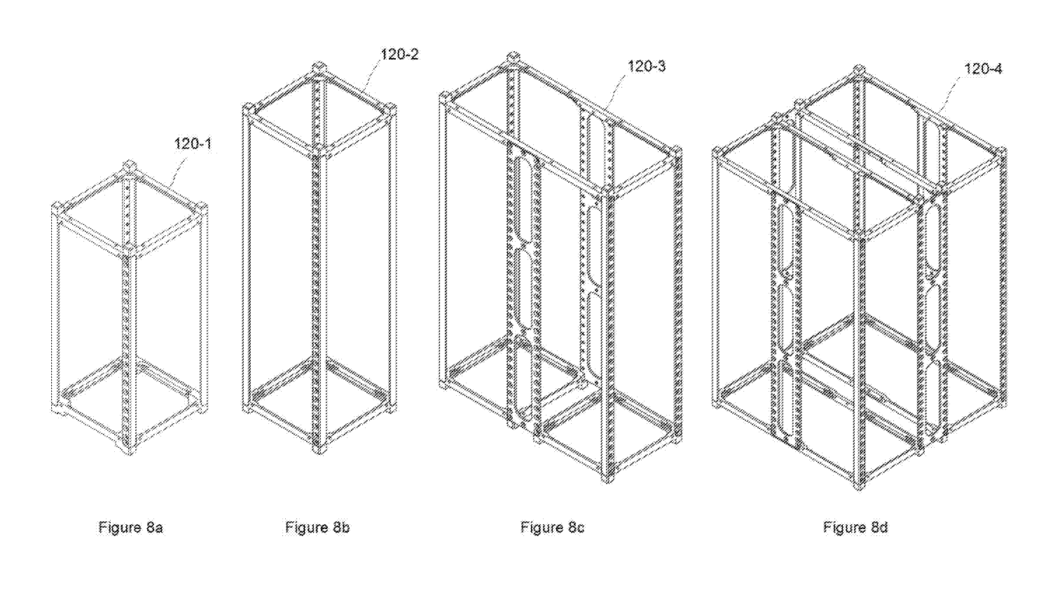

FIGS. 8a to 8d show examples of possible module framework configurations;

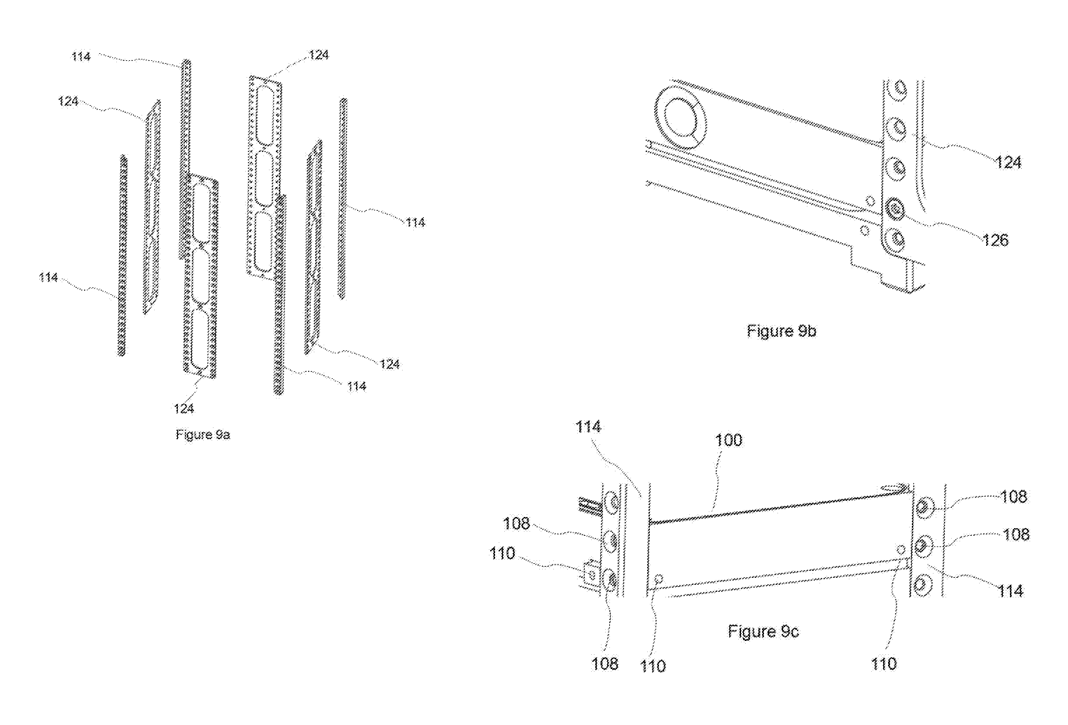

FIGS. 9a to 9c show connecting members for joining adjacent frameworks, how the connecting member may be secured to a framework, and how the apparatus may be secured to a framework, respectively; and

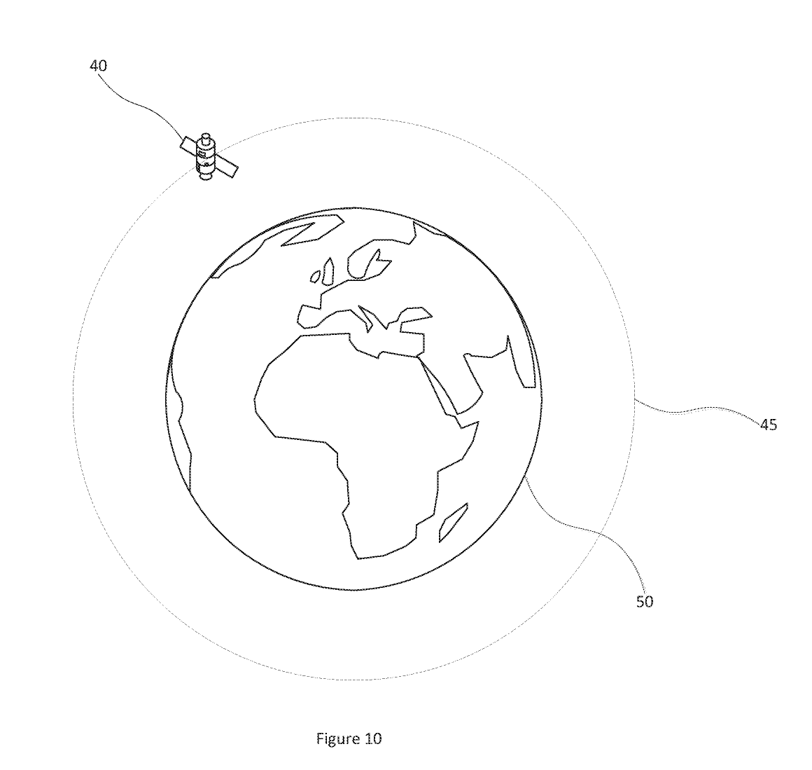

FIG. 10 shows a satellite in orbit carrying a payload tested using an apparatus and/or system and/or method as described herein.

A satellite launcher may be configured to launch multiple small satellites, such as nanosatellites, into orbit, either as primary or secondary payloads on the launcher (e.g. a rocket). A developer of a small satellite may therefore need to configure and/or test their payload for compatibility with the satellite platform upon which it will be launched. This may include developing/testing the payload in various configurations and/or orientations in which it might find itself in orbit, and/or testing the compatibility of the payload with the satellite platform. Such compatibility may include compatibility with the electrical and/or mechanical systems of the satellite, and its related interfaces.

FIG. 1 shows an exemplary embodiment of an apparatus 10 for configuring a payload for a satellite platform (not shown) according to a first embodiment. In other embodiments, the apparatus may be used only for either testing or development of a satellite payload.

The apparatus 10 includes a plurality of structural supports 1 arranged to define a framework having a degree of structural rigidity and robustness for defining a payload volume into which a payload 6 can be placed, mounted and/or fixed. The framework 1 may be arranged to correspond with the structure of an actual satellite platform. The payload 6 as illustrated in FIG. 1 is indicative of an actual payload that may be mounted in the framework 1.

A power supply module 9, which is arranged to be connected to an external power source such as (AC) mains power supply, a generator, a battery, or computer equipment capable of providing power, is provided to supply power to the apparatus 10 via a power port (or interface) 7 provided on the apparatus 10. The power supply module 9 is configured to provide power to a payload 6 in the payload volume when connected to the payload 6 via a payload power interface module 2 provided on the apparatus 10.

The apparatus 10 is also provided with a data interface module 3, which is connected via external data (or communication) link to a general-purpose computer (or other computing device) or is in communication with a computer and/or data network to a remote computing system via a communication interface 8 provided in the apparatus 10. The data interface module 3 can provide a data link between the external data (or communication) link and the payload 6 in the payload volume when connected to the payload 6 via a payload interface 4 provided in the apparatus 10. The apparatus 10 may be configured to communicate with a computer or cloud based system by using a wired or wireless connection, for example.

In another embodiment, the data interface module 3 can be provided along with a power interface module 2 and/or payload interface 4 in an integrated arrangement, for example where only a single wire and/or connector to the payload is used and/or where the same (e.g. a single) physical connector is used to communicate data with a computer and to transmit power from the power supply module 9. Such an integrated arrangement will be discussed in more detail further on.

In the apparatus/system 10 of FIG. 1, the payload 6 is shown mounted in the apparatus/system 10 in a payload volume defined by the structural supports 1 and is fixed in the payload volume using a mechanical interface 5. Power is provided to the payload 6 from the external power supply module 9 via the power interface module 2. A communication bridge is created by connecting the payload 6 to the data interface module 3, which can then be connected to an external computer.

Simulation software can be employed to assist the design and integration of the payload 6 and simulate the satellite activities. Simulation software running on a remote or locally connected computer (via the data interface module 3) is operable to simulate the behaviour of a satellite carrying the payload 6 as if in orbit. The apparatus 10 can therefore be used to simulate orbital mechanics (position and attitude), different attitude control modes, ground passes (including sending telemetry and payload data and receiving commands), and undergoing charging and discharging cycles. The simulation may emulate a number of different spacecraft parameters, including those in respect to size, attitude control capabilities, orbits, solar panels, and relative location of ground stations. Software assisting in one or more of this functions may be stored on a computer local to the apparatus 10, or partially or entirely stored off-site as part of a ‘cloud computing’ application. The software may further be developed to connect multiple spacecraft models together, for example in a constellation arrangement.

In another embodiment, there is provided a satellite comprising the same structure as the development and testing apparatus 10 according to the first or other embodiments. Optionally, in some embodiments the satellite can be a nanosatellite, such as a CubeSat, but other sized satellites are possible in other embodiments.

Where the apparatus 10 is arranged to use exactly the same power supply module 9 and data interface module 3 as a satellite having the same structural framework 1, the performance of the payload may therefore be simulated and evaluated pre-mission, without having access to the actual satellite to do so. Once the satellite is in orbit, the use of the same interfaces and operational functions of the simulation software allow the payload 6 to behave in the satellite as it did when mounted in the development and testing apparatus/system 10. The user is able to monitor the status of the satellite, send commands to its payload 6 and receive the payload data following the same procedures used when the payload simulations were being carried out using the development and testing software and/or apparatus/system 10.

Thus, a developer of a small satellite may first integrate and test their payload 6 into the framework 1, arriving at a desired configuration of the payload in which its performance is expected to meet with their mission requirements, before sending the framework 1 and integrated payload 6 to a satellite launcher to be integrated with a small satellite for launching as a secondary payload of a rocket, or similar launcher.

FIG. 2 illustrates a block diagram of the apparatus 10 shown in FIG. 1 according to the first embodiment.

A computer 20 is coupled to a data interface module 3 via a communication interface 8. The data interface module 3 is coupled to the payload 6 via the payload interface 4. As referred to herein, the term “data interface module” may be used interchangeably with the term “payload communication module”, though the term data interface module 3 is generally used.

The power supply module 9 is connected to both the payload communication module 24 (e.g. data interface module 3) and the power interface module 2. In this example, the payload communication module 24 is also coupled to the power interface module 2 via a power control module 26. The power control module 26 serves to monitor the power being introduced to the payload communication module 24, and can transmit data regarding the power consumption and modulate it should there be a risk of damage to the payload 6. Power from the power supply module 9 is transmitted to the payload 6 via the payload interface 4. As explained above, while the payload interface 4 may be configured to transmit both data and power, it may also comprise a plurality of separate payload interfaces 4 such that data and power can be transmitted separately.

The power interface module 2, data interface module 3, payload interface 4, payload 6 and power control module 26 together comprise a satellite model 35, according to the first embodiment.

FIGS. 3a and 3b show an apparatus 100 according to a second embodiment. The apparatus 100 has two payload data interfaces 102, for transmitting data between the apparatus 100 and a connected payload, and a payload power interface 104, for transmitting power to a connected payload. A further interface 106 is provided, which acts as a combined computer data interface and power supply interface, to receive data from both a coupled computer (not shown) and a power supply (not shown), in this example via the same physical connector. Mechanical interfaces 108 are provided to secure the apparatus 100 to a framework (described below). Further mechanical interfaces 110 are provided to secure (external) closure panels (not shown) at least in part to enclose the apparatus 100 within the framework.

The apparatus 100 may therefore provide a compact core electronics assembly (housing) for a small satellite, including:
a highly integrated and modular assembly of subsystems seen as a black box from the payload side.
a core electronics secondary structure providing radiation shielding and thermal conductive links from the electronics to the primary structure.

Advantages of the apparatus 100 include:
a housing (mechanical assembly) provided by the around the core electronics may permit the subsystems and components inside to have thermally conductive or isolation links tailored to their needs. The design has flexibility built in to reduce non-recurrent costs for missions that need a tailored approach. This is a step-change compared to existing small/nanosatellite derived subsystems, bringing more performance in off the shelf configurations and the flexibility to tailor to a specific mission for very low cost and minimal impact in the rest of the components.
The mechanical assembly of the apparatus 100 may also provide higher radiation shielding level compared to existing CubeSat subsystem assemblies. This may reduce the total ionizing dose increasing the life and reducing radiation affectation of the electronic components.
The mechanical assembly of the apparatus 100 may act as load bearing structure providing interfaces for exterior panels or components. This may bring volumetric and mass efficiencies by using the secondary structure for several purposes.

The apparatus 10, 100 may be (further) configured to perform the following functions:

(1) Data interface management: The data rate is limited according to the conditions of a controller (such as software application), via limiting the data throughput through the data channels to the payload. For instance, a live data link may be simulated from payload to ground segment. If the satellite configuration and the ground segment chosen allow only a 2 mbps link, then the apparatus can limit the data accordingly. If for instance, payload is just transmitting data to the satellite platform bus to be stored and downloaded to ground later on, then the data link speed can be higher, for example hundreds of mbps. Possible data interfaces include: CAN bus, I2C, SPI, LVDS, GPIO.

(2) Power interface management: Similarly, the apparatus can manage the power channels to deliver different voltages and currents. Several power buses can be used and configured at the same time.

Depending on the simulated mission configuration, each power channel might get the current limited, so for example, for a specific part of the orbit the 3.3V channel will only deliver 1 A as maybe the satellite is in eclipse and power needs to be limited to avoid running out of power from batteries. Alternatively, a thermal limitation may apply so high power could be delivered, but only for a short period of time, for example.

FIGS. 4a shows the apparatus 100 mounted within a modular framework 120. An extra ‘dummy’ module 112 is used to simulate the space taken by a specific subsystem in the satellite. Actual subsystems may be used for specific purposes, such as physical actuation of the apparatus 100 to simulate attitude of the satellite. For example, a satellite developer could select a configuration that has extra batteries and a dummy module could therefore simulate the space required by them. FIG. 4b shows an exploded view of FIG. 4a. FIG. 4c shows the configuration of FIG. 4a with the addition of a payload 6.

The framework 120 may comprise a structure made of primary parts with standardized interfaces, including:
main vertical structural members: rails 114 with an equally spaced hole pattern to provide a standardised clear mechanical interface. All the parts of the satellite may be connected to the rails 114. Different design of rails allow for different satellite platform sizes and configurations.
connecting members: ribs 116, stiffeners, horizontal rails, (dummy) payloads, panels. All of these parts may be connected to the rails to provide structural integrity and interfaces for any electronic modules, payloads, end plates, shear panels, exterior panels, exterior components, etc.

The rails (or members) that form the framework 120 can be reused to create configurations of different width, length and/or depth. By using rails of variable and/or different lengths, various different configurations of width, length and/or depth are possible for a framework 120, which can be easily reconfigured. A plurality of ribs 116 are provided within the framework 120 to section off volumes or compartments of the framework 120.

Advantages of the modular framework 120 structure include:
it may permit more flexibility for the payload to be the volume, shape and mechanical interfaces that most suit the mission requirements. The payload does not need to be designed around the framework 120 but the framework 120 has enough flexibility to permit a higher number of options compared to existing nanosatellite off the shelf frameworks. Possibility of payloads substituting part of the framework (of the satellite) are enabled as well.
It may permit more flexibility for orientation and mounting arrangements of the nanosatellite core bus compared to existing nanosatellite concepts. This may permit more flexibility to the payload as well.
exterior solar panels tend to be mission specific, hence the structural concept presented may permit a higher flexibility to tailor the solar/exterior panels to the mission.
the commonality of parts among different size of nanosatellites may permit reduction in costs and times due to higher units manufactured.
the standard interface and compatibility of structural parts between different size of nanosatellites may permit punctual modifications carried out for specific missions to be incorporated as another option for the modular framework 120 structure.

FIGS. 5a and 5b show an apparatus 100 mounted in a modular framework 120 in two different positions and orientations (or “configurations”). The framework 120 may have fixed pitch holes, which allow new mechanical modules to be easily mounted. As mentioned above, the framework 120 is, preferably, modular. The empty volume 118 shown in the figures would be taken by satellite subsystems and potentially filled with volume dummies or real subsystems.

FIGS. 6a and 6b show a further configuration of an apparatus 100 mounted in a modular framework 120, and that same configuration with the addition of a payload 6, respectively. As shown in FIG. 6B, the payload 6 itself may have an external structure that can substitute for part of the framework 120, for example where shorter framework rails 120 enable exterior payloads to be integrated.

FIGS. 7a and 7b show two different framework 120 configurations having an apparatus 100 and a dummy module 112, similar to as shown in FIG. 4, with payloads 6 mounted within the framework 120. In both FIGS. 7a and 7b, several ribs of the framework 120 have been removed to accommodate the size of the payload 6. FIGS. 7a and 7b are differentiated in that they have different end-plates 122-1, 122-2, with the end-plates 122-2 of FIG. 7b acting to help inhibit movement of the payload 6.

FIGS. 8a to 8d show examples of possible modular framework 120 configurations, illustrating the advantage that, by using the same parts, it is possible to create different framework structures, and thus mix and match parts. This approach brings a step change in flexibility and reduces manufacturing costs, for example in mocking up the framework structures for small satellites.

FIG. 9a shows a plurality of connecting members 124 and rails 114 for securing adjacent frameworks 120 together. FIG. 9b shows how the connecting member 124 may be secured to a framework 120, in use, using fasteners 126 (e.g. screw fasteners). FIG. 9c shows how the apparatus 100 may be secured to a framework, via a mechanical interface 108 provided for that purpose on the apparatus 100, and using fasteners (e.g. screw fasteners) to secure it to a vertical rail 114 (or member) of the framework 120. Closure panel interfaces 110 are also shown provided on the apparatus 100 for fastening a closure panel (not shown). The closure panel may of course alternatively, or additionally, be adapted to be fastened to the framework 120 itself.

FIG. 10 shows a satellite 40 while in use in orbit 45 around the Earth 50. At an appropriate time following a launch, usually via a rocket, the satellite 40 detaches from the rocket and begins its orbit 45. Satellite orbits 45 may vary significantly depending on the purpose of the satellite 40. Low Earth Orbits (LEO) are common orbits for small satellites. Satellites in LEO are conventionally between 200 km and 2000 km above the surface of the Earth. The satellite 40 can use many of the same or similar modules and elements as described in relation to the development and testing apparatus of the above embodiments. The satellite 40 can contain a payload that has been developed and tested using the development and testing apparatus.

In some embodiments, the simulation software can provide some or all of the following functions: Full orbit simulation; Coverage during operations simulation; Satellite mode manager simulation; Attitude control system power-on, power-off and reset; Set Unix time; Attitude control system run mode; Set attitude estimation mode; Set attitude control mode settings and script; Set attitude angles; Get pointing performance; Set start-up mode; Attitude and angular simulation in 3D display; Satellite position simulation; Satellite velocity simulation; SGP4 orbit simulation; Link budget settings and simulation; Datalink budget; Ground station visibility and planning; Communication protocol and packet format settings; Real time communication interface between payload and satellite system; Transceiver run mode simulation; Transceiver communication simulation; Housekeeping simulation (e.g. battery level, payload power interface current, payload power interface voltage, current protection simulation); Set power interface output; Solar panel voltage and current simulation; Power system temperature simulation; Payload power interface initial settings; EPS modes simulation; Satellite temperature of different components, e.g. solar panels, structure, payload bay; and Heat fluxes to and from the payload.

The apparatus and system described herein may provide hardware-in-the-loop, whereby a software application can take into account the performance of the real subsystems in the satellite and provide simulations based on this information. For example, if a satellite developer selects a battery pack, the software could take into account the available energy for that mission and assess the suitability of the chosen configuration.

The software application may also be fed from the real performance of subsystems from orbit and ground tests, making the simulations more accurate. The software application may also inform the developer about the real launch and ground segment opportunities available. So if the developer selects a specific orbit, the software application can inform them of the launch opportunities, timeline and conditions. Ground segment availability and characteristics could also be shown and feed the simulation results. For example, the amount of downlink data for a specific configuration may be affected by the ground station configuration and the simulation can recommend a more suitable option.

The software application can thereby provide a mission simulator, such that a developer can select the mission parameters they want to simulate, for example: orbit, satellite configurations (e.g. this amount of battery, more coarse or more fine attitude systems, different frequency and data rate transceivers), etc.

Furthermore, the developer can use the same software application to operate and/or command the payload once satellite is in orbit using the same interface(s) as used during payload development. The software application can take into account safe boundaries in order to enable satellite developers to control the payload within safe satellite boundaries, for example adversely controlling the attitude of the satellite such that it dangerously affects the power intake.

Many different methods of manufacture may be used to produce any of the components mentioned in relation to this apparatus, and in particular the framework and/or the connecting members. For example, components of one or more embodiments described herein may be manufactured by way of ‘3D printing’ whereby a three-dimensional model of one of the various options for the hand-held objects are supplied, in machine-readable form, to a ‘3D printer’ adapted to manufacture said one or more components. This may be by additive means such as extrusion deposition, Electron Beam Freeform Fabrication (EBF), granular materials binding, lamination, photopolymerization, or stereolithography or a combination thereof. The machine-readable model comprises a spatial map of the object or pattern to be printed, typically in the form of a Cartesian coordinate system defining the object's or pattern's surfaces. This spatial map may comprise a computer file which may be provided in any one of a number of file conventions.

One example of a file convention is a STL (STereoLithography) file which may be in the form of ASCII (American Standard Code for Information Interchange) or binary and specifies areas by way of triangulated surfaces with defined normals and vertices.

An alternative file format is AMF (Additive Manufacturing File) which provides the facility to specify the material and texture of each surface as well as allowing for curved triangulated surfaces. The mapping of the object may then be converted into instructions to be executed by 3D printer according to the printing method being used. This may comprise splitting the model into slices (for example, each slice corresponding to an x-y plane, with successive layers building the z dimension) and encoding each slice into a series of instructions. The instructions sent to the 3D printer may comprise Numerical Control (NC) or Computer NC (CNC) instructions, preferably in the form of G-code (also called RS-274), which comprises a series of instructions regarding how the 3D printer should act. The instructions vary depending on the type of 3D printer being used, but in the example of a moving printhead the instructions include: how the printhead should move, when/where to deposit material, the type of material to be deposited, and the flow rate of the deposited material.

Any part of an apparatus as described herein may be embodied in one such machine-readable model, for example a machine-readable map or machine-readable instructions, configured to enable a physical representation of said part of apparatus to be produced by 3D printing. This may be in the form of a software code mapping of one or more components and/or instructions to be supplied to a 3D printer (for example numerical code).

Any system feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

1. An apparatus for development and/or testing of a payload for a satellite, comprising:
a payload interface operable to connect to the payload; and
a communication link, operable to couple the apparatus with a computer;
wherein the apparatus is operable to emulate one or more subsystems of the satellite, such that the behaviour of the payload when connected to the apparatus via the payload interface and communication link is the same as when in the satellite.

2. An apparatus according to claim 1, further comprising a data interface module operable to be connected to the payload via the payload interface, such that data can be communicated between the computer and the payload via the data interface module.

3. An apparatus according to claim 1 or 2, further comprising a power interface module operable to be coupled to a power supply, whereby to supply power to the payload via the payload interface.

4. An apparatus according to claim 3, wherein the power interface module is operable to receive power from a power supply including at least one of: mains supply, generator, battery and a computer.

5. An apparatus according to claim 3 or 4, wherein the power supplied to the payload comprises a potential difference of between 1 and 24 volts, for example one of: 3.3 volts; 5 volts; 12 volts; or 24 volts.

6. An apparatus according to any preceding claim, wherein the payload interface is operable to supply both data and power to the payload.

7. An apparatus according to any of claims 1 to 6, further comprising a housing for the payload interface and/or communication link, and preferably also for the data interface module and/or the power interface module according to any of claims 2 to 6.

8. An apparatus according to claim 7, wherein the housing is arranged to have substantially the same dimensions as one or more subsystems of the satellite to be used with the payload.

9. An apparatus according to claim 7 or 8, wherein the housing comprises at least one mechanical interface for securing the apparatus to another structure, framework and/or panel.

10. An apparatus according to any of claims 2 to 9, wherein the data interface module and/or power interface module is/are operable to be controlled by the computer to simulate conditions that the payload may undergo in the satellite, for example when the satellite is in orbit, such that behaviour of the payload under such conditions can be monitored and/or the payload operated.

11. An apparatus according to claim 10, wherein the simulated conditions provide data on one or more of: position; attitude and orbit control subsystem properties; power subsystem parameters; run mode; power control; deployables status; electronics system configuration; firmware management; reset settings; thermal subsystem parameters and control; or redundancy settings.

12. An apparatus according to any preceding claim, further comprising a payload mounting framework defining a payload volume, for example to which to mount the payload.

13. A system for development and/or testing of a payload for a satellite, comprising;
a framework for supporting the payload in a desired orientation; and
an apparatus according to any of claims 1 to 11.

14. A system according to claim 13, further comprising a controller arranged to control the apparatus, for example wherein the controller is a computer.

15. A system according to claim 13 or 14, further comprising a power supply module arranged to supply power to the apparatus.

16. An apparatus or system according to any of claims 12 to 15, wherein the framework is modular, preferably wherein the size of the framework can be reconfigured, for example wherein the framework comprises two or more separate frame modules connected together.

17. An apparatus or system according to claim 16, wherein the two or more adjacent frame modules are secured together by connecting members.

18. An apparatus or system according to any of claims 12 to 17, wherein the framework may be configured to correspond with the dimensions of the satellite, for example wherein the satellite is a CubeSat, optionally with a configuration of between 1U and 12U.

19. An apparatus or system according to claim 18, wherein the framework is arranged to define a payload volume that is substantially the same volume as the payload volume of the satellite.

20. An apparatus or system according to any of claims 12 to 19, wherein the framework includes one or more partitions for compartmentalising the framework, for example wherein the partitions are provided by one or more rib members.

21. An apparatus or system according to any of claims 12 to 20, wherein the framework is configured such that at least a portion of the framework can be replaced with a payload or a dummy payload, whereby to maintain structural integrity of the framework.

22. An apparatus or system according to any of claims 12 to 21, further comprising one or more panels arranged at least in part to enclose at least a section of the framework.

23. A system according to any of claims 13 to 22, further comprising a ‘dummy’ module arranged to simulate the volume and/or mass properties of one or more subsystems in the satellite, for example wherein the dummy module is arranged to fit within the framework, for example wherein the dummy module is arranged to be integrated as part of the structure of the framework.

24. A machine-readable map, or machine-readable instructions, configured to enable a 3D printer (or any printer or manufacturing device/system) to manufacture the framework and/or connecting members and/or dummy module according to any of claims 12 to 23.

25. A method for development and/or testing of a payload for a satellite, the method comprising the steps of:
connecting the payload with an apparatus according to any of claims 1 to 11; and
performing one or more simulations on the payload to determine the likely behaviour of the payload in orbit.

26. A method according to claim 25, further comprising mounting the payload in a desired orientation within a framework that corresponds to the structure of the satellite.

27. A method according to claim 25 or 26, wherein the one or more simulations are performed on a computer that is coupled to the apparatus.

28. A method according to any of claims 25 to 27, further comprising the step of determining the behaviour of the payload under varying environmental conditions, for example wherein the payload and apparatus are placed in an appropriate test chamber.

29. A method according to claim 28, wherein the environmental conditions may comprise one or more of: a reduction in air pressure, vibration of the apparatus; a reduction or increase in ambient temperature; and a change in the radiation levels.

30. A method for developing and/or testing a payload for a satellite, the method comprising:
simulating one or more conditions of a space mission on a computer;
controlling the payload to undergo one or more of said simulated conditions; and
monitoring the payload to determine its behaviour while undergoing the one or more simulated conditions.

31. A method according to claim 30, wherein the computer is operable to act as a spacecraft simulator providing data on one or more of: position; attitude and orbit control subsystem properties; power subsystem parameters; run mode; power control; deployables status; electronics system configuration; firmware management; reset settings; thermal subsystem parameters and control; or redundancy settings.

32. A method according to claim 30 or 31, wherein the simulation is created using actual space flight data, for example obtained from previous missions.

33. A method according to any of claims 30 to 32, wherein the computer is further operable to simulate multiple satellites simultaneously and/or inter-satellite communication.

34. A method according to any of claims 30 to 33, wherein the payload is connected to an apparatus according to any of claims 1 to 11.

35. A computer program product adapted to perform the method of claims 30 to 34.

36. A computer program product according to claim 35, further adapted to control the payload in the satellite, for example by using the same user interface for both the simulation and the actual control.

37. An apparatus, system or method according to any preceding claim, wherein the payload is for a satellite having a wet mass of less than 500 kg, preferably a satellite having a wet mass of between 1 kg and 25 kg, and more preferably a nanosatellite, for example a CubeSat.

38. A satellite for use with a payload developed and/or tested using the apparatus, system and/or method according to any previous claim, preferably wherein the satellite is small satellite, and more preferably a nanosatellite, for example a CubeSat.

39. An apparatus or system substantially as herein described and/or as illustrated in the accompanying Figures.
